(19) United States
(12) Patent Application Publication
(10) Pub. No.: US 2006/0092129 A1
(43) Pub. Date: May 4, 2006

(54) Human machine interface for vehicle

(75) Inventors: Alain Choquet, Lesquin (FR); Michael Weiss, Pulheim (DE); Simon Harris, Essex (GB)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/225,526

(22) Filed: Sep. 13, 2005

Related U.S. Application Data
(60) Provisional application No. 60/620,600, filed on Oct. 20, 2004.

(51) Int. Cl. G09G 5/00

(52) U.S. Cl. 345/156

(57) ABSTRACT

A human machine interface includes a knob with an integrated electronic display located in the center of the knob. The knob may be used for operation with multiple functions corresponding to a menu on the electronic display. A plurality of buttons are located about the knob in the form of a circle and correspond to menu selections provided on the display.

### CROSS REFERENCE TO RELATED APPLICATIONS

This application claims the benefit of U.S. provisional patent application No. 60/620,600, filed Oct. 20, 2004, which is incorporated herein by reference.

### BACKGROUND

1. Field of the Invention

The present invention generally relates to a human machine interface (“HMI”) for a vehicle and more particularly for an HMI for a vehicle.

2. Description of Related Art

Generally, interface designs try to maintain a one-to-one relationship between the controls and functions of the interface. Maximizing the one-to-one relationship of the functions to the controls of an interface provides intuitive navigation and improves ease of use of the system. In practice, many interfaces have buttons that control multiple functions of the interface by graphically associating the buttons with menu choices on a common display.

Today the number of controls for many interface units is limited by the cost of creating individual buttons and controls for each function. Additionally, as the number of controls increase, the space required for the additional controls translates into higher cost and creates implementation problems for the design engineers. Often budget and space constraints drive a reduction in interface optimization, even for high end customers.

In view of the above, it is apparent that there exists a need for an improved human machine interface.

### SUMMARY

In satisfying the above need, as well as overcoming the enumerated drawbacks and other limitations of the related art, the present invention provides such an improved human machine interface.

The human machine interface (HMI) includes a large ring knob with an integrated display, in the center of the ring knob, for operation with multiple functions. A plurality of buttons are located about the ring knob in the form of a circle and correspond to menu selections provided on the display. In addition, a finger rest is located above the ring knob for hand stabilization during use of the ring knob or buttons.

A proximity sensor is provided to sense user motion proximate the HMI unit. The proximity sensor signals a controller to copy content from the integrated display to a multifunction display in the instrument cluster or a heads up display to enable blind operation. In addition, a touch sensor is integrated on the ring knob to enlarge the adjustment display upon user contact. To avoid confusion of the driver, an enlarged display of the control function currently being manipulated is provided to the user. In addition, the enlarged display may include a symbol corresponding to the control function being manipulated. A portion of the background or other part of the display may be “filled-in”, where the fill area corresponds to the setting or level of the current control function. The background filling provides maximum visualization to the user and is easily rationalized by analogy, such as, the filling of a glass with water.

Menu buttons are provided for each function category. Preferably, each category function has no more than two menus per menu button. Two menus per button, allows the user to return to the desired main menu with one activation of any menu button. This enables an easily learnable HMI and reduces driver distraction while manipulating menus.

An arrangement of four ring segment buttons is provided around the display and ring knob. The operation of each button is supported by a visual feedback including the activation feedback and status feedback within the associated quarter segments of the round display integrated into the ring knob. Using a round display allows more styling flexibility and the division of the circle into four quarters provides a clean way for associating the four control functions to the four buttons that can be operated simultaneously. To provide further styling, the layout of the four ring segment buttons appear as a single ring or circle in the HMI unit.

In an additional embodiment, the HMI unit is a panel that can be flipped up to provide access to a storage unit behind the HMI controls. This area is usually used for audio or climate control electronics, and as such the audio and climate control electronics can be located elsewhere in the car and remotely operated by the HMI unit. In addition, a storage unit in the center console is a preferred location for personal storage because it can be accessed while driving. Typical storage units are much further away from the driver's view, such as, the glove box or under a seat. Further, wireless data streaming may be used to communicate with mobile consumer and communication electronics located in the storage unit. A transmitter/receiver may be integrated to the storage unit and connected to a controller to wirelessly integrate the function of stored electronics into the vehicle electronic system.

For each function category, the HMI includes a set of dedicated controls. In addition, some controls are multiplexed to manipulate functions belonging to all function categories. The layout of the HMI is designed such that controls corresponding to each function category are contained in a unique region and multiplexed controls associated with multiple categories are located between each of the unique regions. As such, the driver can build a mental model of the control elements, because the functional groups are in separate areas. Further, the display color including a ring light or menu accents are manipulated to be consistent with the currently active function category. Each function category has a predefined color which may be altered based on daylight or nighttime illumination.

In addition, each of the knobs include a unique tactile indicator, for differentiation by feel. The tactile indicator may include the profile of the knob surface which is different for each knob. Using unique knob surface profiles is a cost effective solution to enable blind operation of the controls and improved differentiation for a number of similarly styled control knobs.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a front perspective view of an HMI unit in accordance with the principles of the present invention;

FIG. 2 is a schematic view of an HMI unit in accordance with the present invention;

FIG. 3 is a front perspective view illustrating use of a finger rest in accordance with the present invention;

FIG. 4 is a front perspective view illustrating activation of the touch sensor in accordance with the present invention;

FIGS. 5A, 5B and 5C are a front view of the integrated display illustrating an enlarged display with background filled-in accordance with the present invention;

FIG. 6 is a schematic view of the menu control of the HMI in accordance with the present invention;

FIGS. 7A and 7B is a front view of the electronic display illustrating visual confirmation of control manipulation in accordance with the present invention;

FIG. 8 is a front perspective view illustrating use of the proximity sensor in accordance with the present invention;

FIG. 9 is a front perspective view of the HMI unit and a instrument cluster illustrating remote display of the HMI display information in accordance with the present invention;

FIG. 10 is a front perspective view illustrating the first region containing controls associated with a first function category in accordance with the present invention;

FIG. 11 is a front perspective view illustrating the second region containing controls associated with a second function category in accordance with the present invention;

FIG. 12 is a front perspective view of the HMI unit including a storage unit in accordance with the present invention; and

FIG. 13 is a front perspective view of the HMI unit including an integrated air register unit in accordance with the present invention.

### DETAILED DESCRIPTION

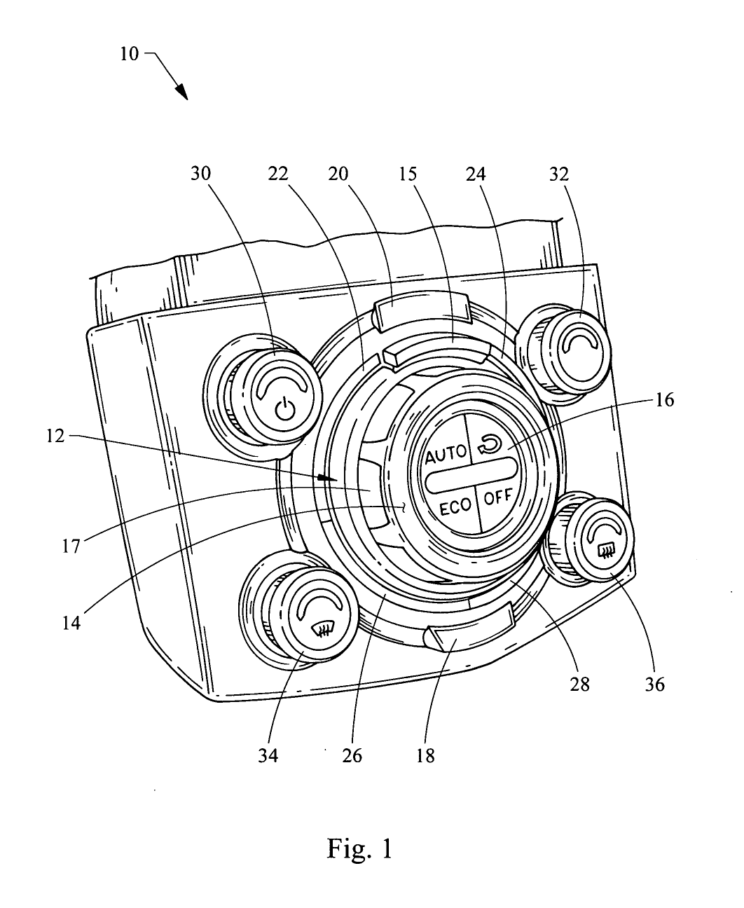

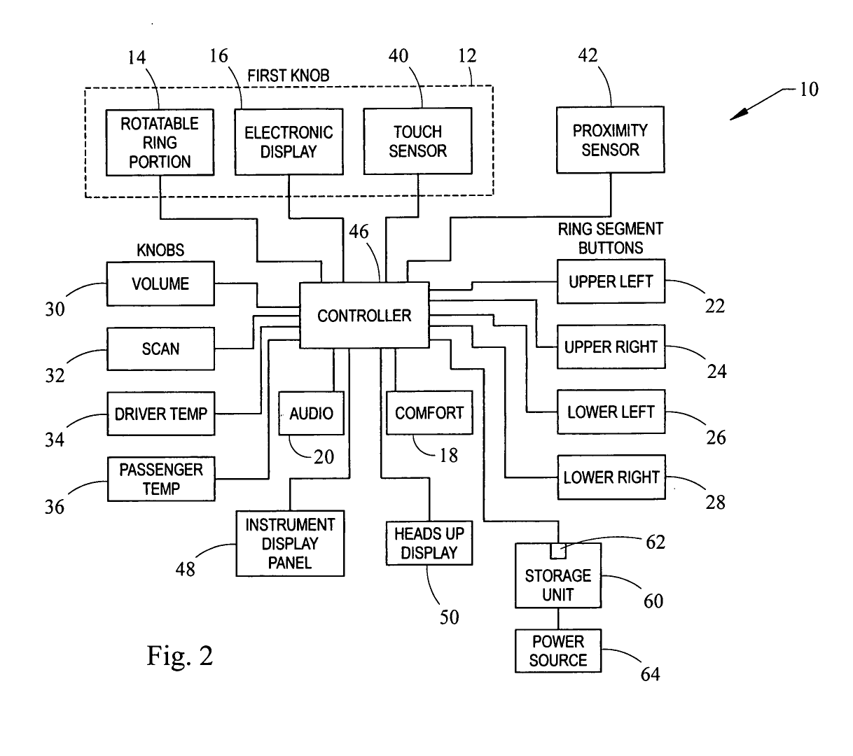

Referring now to FIGS. 1 and 2, a human machine interface (HMI) unit embodying the principles of the present invention is illustrated therein and designated at 10. The HMI unit 10 includes various controls, an integrated display and a controller in communication with both the controls and display.

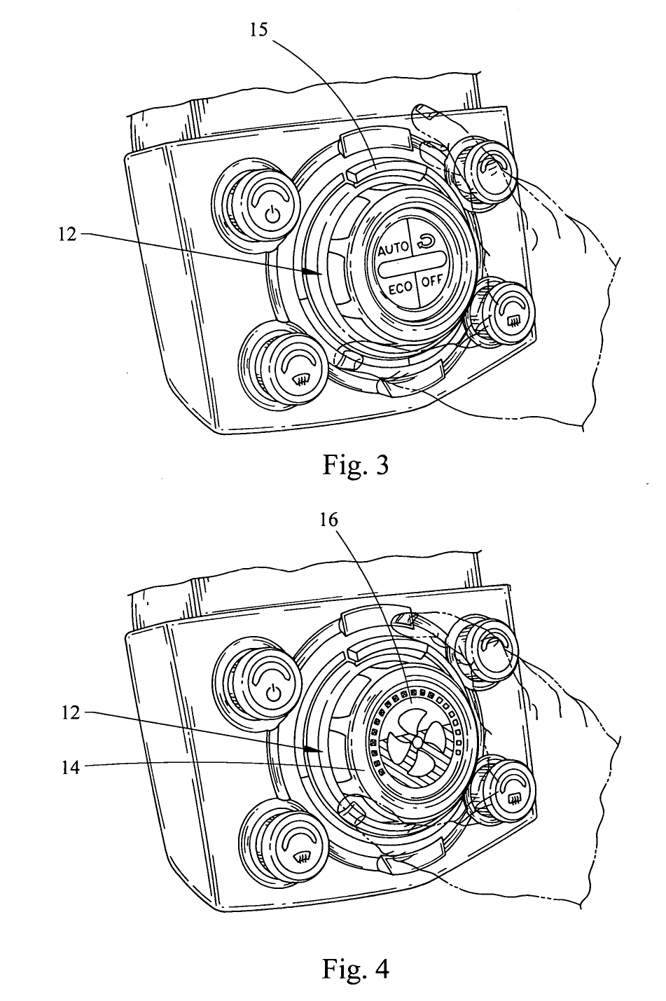

One control comprises a first knob 12 located central to the HMI unit 10 and includes an integrated electronic display 16. The first knob 12 includes a rotatable ring portion 14 located about the electronic display 16. The rotatable ring portion 14 has finger grips 17, preferably a tacky material for improved manipulation of the first knob 12. Positioned immediately above the first knob 12 and partially extends around the first knob 12 is a protrusion 15. As such, the protrusion 15 is available to the user as a finger rest allowing hand stabilization as the user manipulates the first knob 12, as illustrated in FIG. 3.

The first knob 12 also includes a touch sensor 40, to determine when the first knob 12 is being touched by the user as illustrated in FIG. 4. A controller 46, in communication with the touch sensor 40, is configured to alter the information provided on the electronic display 16 based on the touch sensor 40. The information may be altered such that display information related to the controlled setting may be formatted to temporarily occupy the full display area. In addition, the information may include graphics indicating the setting for the function of the first knob 12.

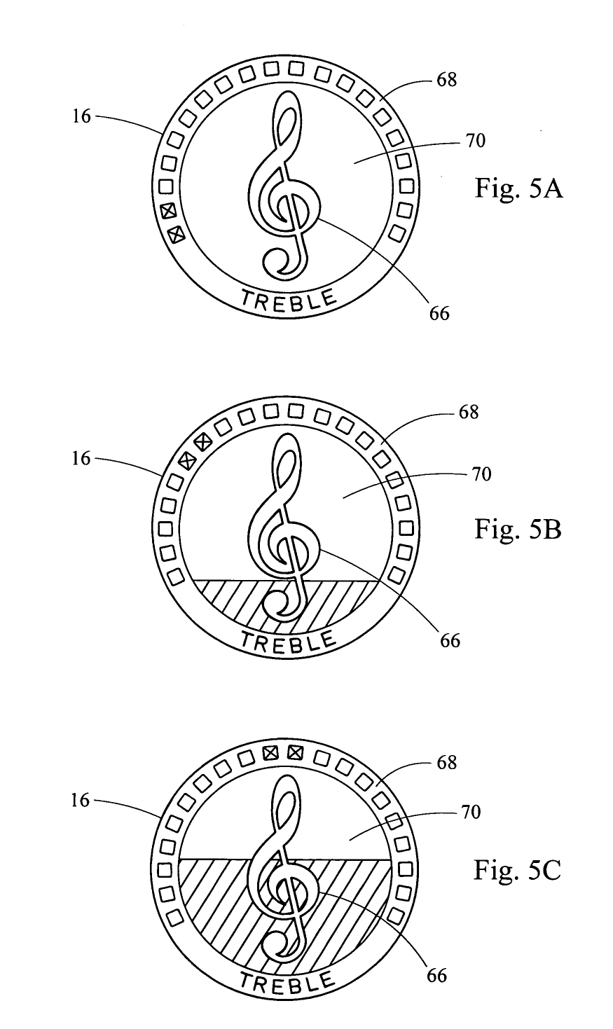

One example of the graphics provided to the electronic display 16 is depicted in FIG. 5. If the first knob 12 is configured to control the treble selection of an audio device, when the first knob 12 is touched the electronic display 16 may be altered to include additional information or formatting about the treble selection. For example, the electronic display 16 may include a treble cleft symbol 66 indicating the treble selection is being manipulated. The symbol 66 may be an illuminated outline of the symbol with textual naming of the control function across the bottom of the electronic display 16. The controller 46 may further be configured to control the electronic display 16 and provide visual indicators showing the level of the current setting. For example, along the top of the display, a box graph 68 may be provided to indicate the current treble setting. An animated filling of the boxes on the box graph 68 provides a somewhat linear indication of the treble setting. Further, an animated filling of the background 70 around the symbol provides an alternative or additional area based visual indication of the current setting. If the treble setting is half way between the maximum and minimum treble setting, the background 70 would be half filled, as seen in FIG. 5C. Similarly, a treble setting one quarter of the way toward the maximum treble setting would result in the background 70 being one quarter filled, as seen in FIG. 5B. In addition, the filled portion may also be indicated by a change in color, brightness, or other visual characteristic.

Ring segment buttons 22, 24, 26, 28 are located around the first knob 12. In the embodiment shown, there are four ring segment buttons. The ring segment buttons are in the shape of an arc and are located in a circular arrangement around the first knob 12. The ring segment buttons may extent around the first knob 12 such that the ring segment buttons appear as a continuous circle surrounding the first knob 12. The four ring segment buttons 22, 24, 26, 28 are in communication with the controller 46 and are coordinated with the electronic display 16, such that, the function of each button is indicated in an adjacent quadrant of the electronic display 16. Further, the function of each button may change based on the menu or control mode of the HMI unit 10.

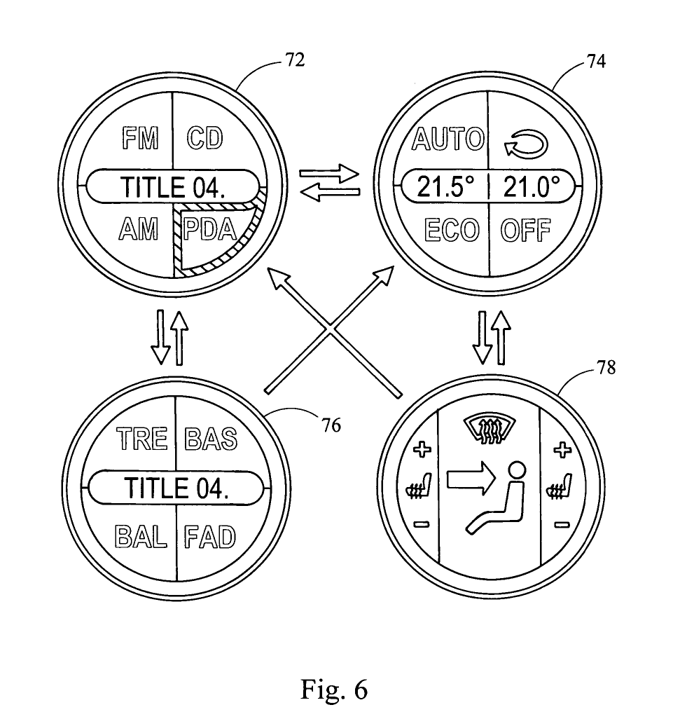

The HMI unit 10 also includes at least two menu buttons 18, 20. The menu buttons 18, 20 allow the user to index through menus for a category of functions. As shown, the HMI unit 10 includes a first menu button 18 for accessing comfort functions and a second menu button 20 for accessing audio functions. Preferably, each menu button indexes through four menus 72, 74, 76, 78 that assign functionality to the ring segment buttons and the rotatable ring portion 14 of the first knob 12. As such, any menu may be accessed with two presses of an associated menu button, as shown in FIG. 6. The menu buttons may be color coded, for example, red for audio and blue for comfort. The menu colors or accents may also correspond to the color theme for the associated menu categories (comfort or audio). In addition a ring light located proximate the first knob may be provided to illuminate a portion of the HMI unit in a color corresponding to the current menu category.

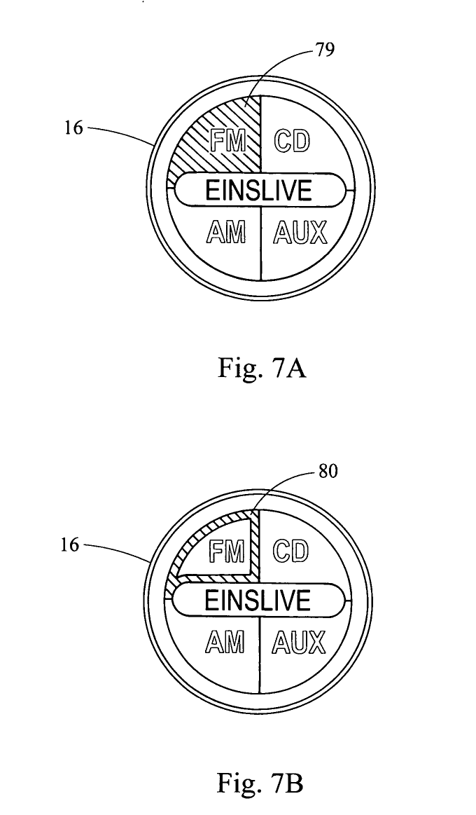

Illustratively, the first menu button 18 provides the user with the ability to manipulate comfort functions. If the first menu button 18 is pressed once, the most important comfort functions would be provided to the user. Generally, these functions would include functions such as AUTO/MANUAL, RECIRCULATION ON/OFF, BLOWER ON/OFF, AC ON/OFF. The electronic display 16 provides indicia in each of the four quadrants of the display area indicating either the function or the status of each function controlled by the corresponding ring-segment button. When the ring-segment button is pressed the corresponding quadrant of the electronic display is highlighted 79. As shown in FIG. 7, the information in the corresponding quadrant is inverted (bright background and dark lettering) as the button is depressed. Further, the quadrant remains outlined using a bold line 80 while the function remains active.

The buttons may directly toggle the setting for the function and update the electronic display 16. For example, the upper left quadrant of the electronic display 16 includes indicia indicating the status of the MANUAL/AUTO temperature function. If the status was AUTO, “AUTO” would be displayed in the upper left quadrant of the electronic display 16. Pressing the upper left ring-segment button 22 would index the status of the MANUAL/AUTO function and update the indicia on the electronic display 16. Therefore, if the status was AUTO and the upper left ring-segment button 22 were pressed, the status would index to MANUAL and “MAN” would be displayed in the upper left quadrant of the electronic display 16.

In addition, other sections of the electronic display, including the middle and periphery of the screen, may show, on demand information such as, Radio Data System (RDS) information, reception frequency, selected temperature, volume, or other useful variables.

Similar to the MANUAL/AUTO function, the upper right ring segment button 24 would index the recirculation ON/OFF setting. While the lower left ring segment button and lower right ring segment button would index the status of AC ON/OFF and BLOWER ON/OFF functions respectively.

Pressing the menu button 18 a second time will provide a menu including additional functions relating to the comfort category. This menu will specifically include functions related to air distribution and seat heating controls. Pressing the upper left ring segment button 22 increases the driver's seat heat and pressing the upper right segment button 24 increases the passenger's seat heat. Similarly, pressing the lower left ring segment button 26 decreases the driver's seat heat and pressing the lower right segment button 28 decreases the passenger's seat heat. In addition, rotation of the first knob 12 controls the air distribution settings. Further the electronic display 16 includes symbols indicating the function of each corresponding ring segment button.

The second menu button 20 provides the user with the ability to manipulate audio functions. If the second menu button 20 is pressed once, the menu will provide the user with an audio source selection. The upper left quadrant of the electronic display includes an “FM” indicator indicating the upper left ring selection button 22 controls the “FM” source selection. To visually confirm the upper left ring segment button 22 has been pressed, the “FM” in the upper left quadrant of the electronic display will be inverted. Pressing the upper left ring-segment button 22 would select the FM audio source. To continuously indicate the FM sources selection, the “FM” on the electronic display will be highlighted. These visual confirmations are depicted in FIGS. 7A and 7B.

After the FM audio source has been selected, the ring segment buttons may be used for additional functions relating to the FM audio source. For example, the upper left ring button 22 may be used for a traffic program on/off function. The upper right ring segment button 24 may be used for an auto search on/off function. While the lower left and lower right ring segment buttons 26, 28 may be used for seek down and seek up functions, respectively. In addition, the rotatable ring portion of the first knob 12 may be used to control manual tuning of radio. Unused portions of the electronic display may be used to provide related information, such as the current reception frequency.

Referring again to the menu provided after the pressing the second menu control button 20, the upper right quadrant includes a “CD” designation indicating the upper right ring segment button 24 selects the CD audio source. Accordingly, if the upper right ring segment button 24 is selected, the ring segment buttons may be used for CD related control functions.

The lower left quadrant includes an “AM” designation indicating the lower left ring segment button 26 selects the AM radio audio source. Accordingly, if the lower left ring segment button 26 is selected, the ring segment buttons may be used for AM radio related control functions.

The lower right quadrant includes an “AUX” designation indicating the lower right ring segment button 28 selects the AUX audio source. Accordingly, if the lower right ring segment button 28 is selected, the ring segment buttons may be used for auxiliary related control functions.

For each of the above audio sources, unused portions of the electronic display may be used to provide related information including on/off status, station, song title, artist information, etc.

Pressing the second menu button 20 a second time will provide a menu including additional functions relating to the audio category. This menu may specifically include functions related to sound control. For example, pressing the upper left ring segment button 22 selects the treble function. After the treble function is selected, the rotation of the first knob 12 adjusts the current treble settings. Pressing the upper right segment button 24 will select the bass function. The rotation of the first knob 12 therefore adjusts the current bass settings, after the bass function has been selected. Similarly, pressing the lower left ring segment button 26 selects the balance function and pressing the lower right segment button 28 selects the fade function. After the balance or fade function is selected, the rotation of the first knob 12 adjusts the current balance or fade setting respectively. If none of the functions on the menu are selected then the rotation of the first knob 12 has no effect. Further the electronic display includes symbols in each quadrant indicating the function of each corresponding ring segment button.

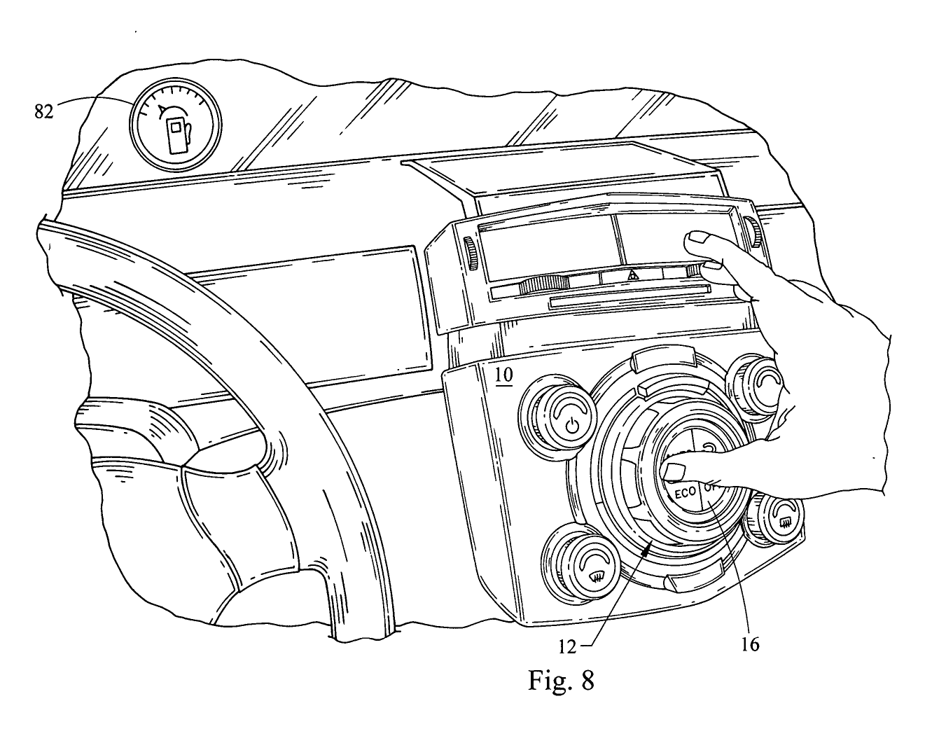

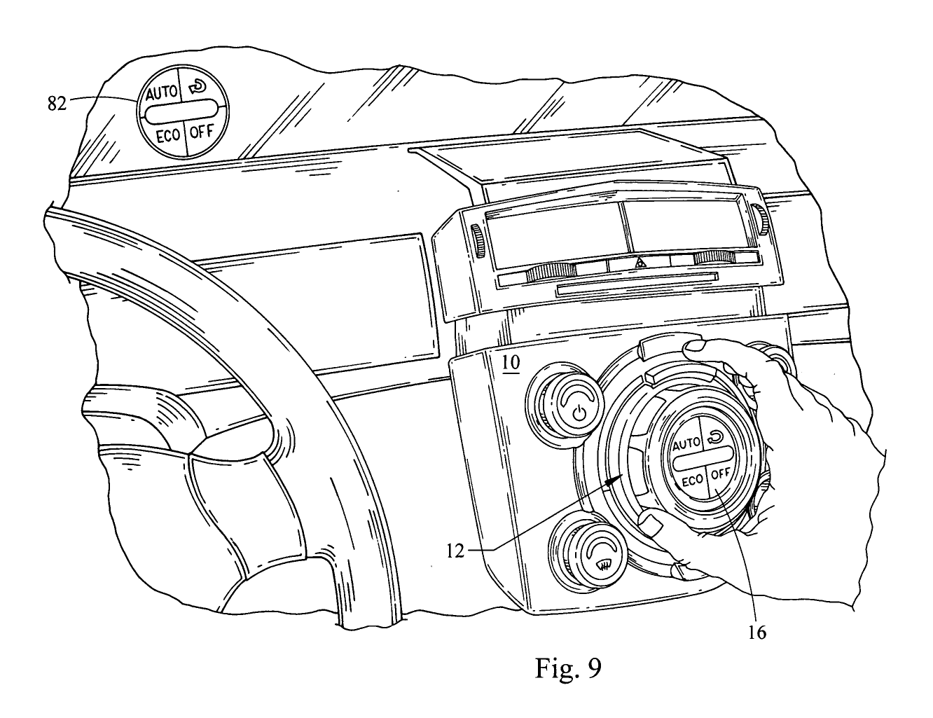

Referring now to FIGS. 8 and 9, the HMI unit 10 includes a proximity sensor configured to detect if the users hand is approaching the HMI unit 10. The controller 46 is in communication with the proximity sensor 42 and configured to display information related the HMI unit 10 on an additional display unit. In one instance, the display information is provided to the main instrument cluster 48 located in front of the driver. In another instance, the display information may be provided to a heads-up display 50 and projected into the driver's field of view. The projected display information 82 may be a duplicate of the information provided in the electronic display 16 and may even have the same graphical format. Alternatively, the information may be reformatted to better utilize the display area of the additional display unit.

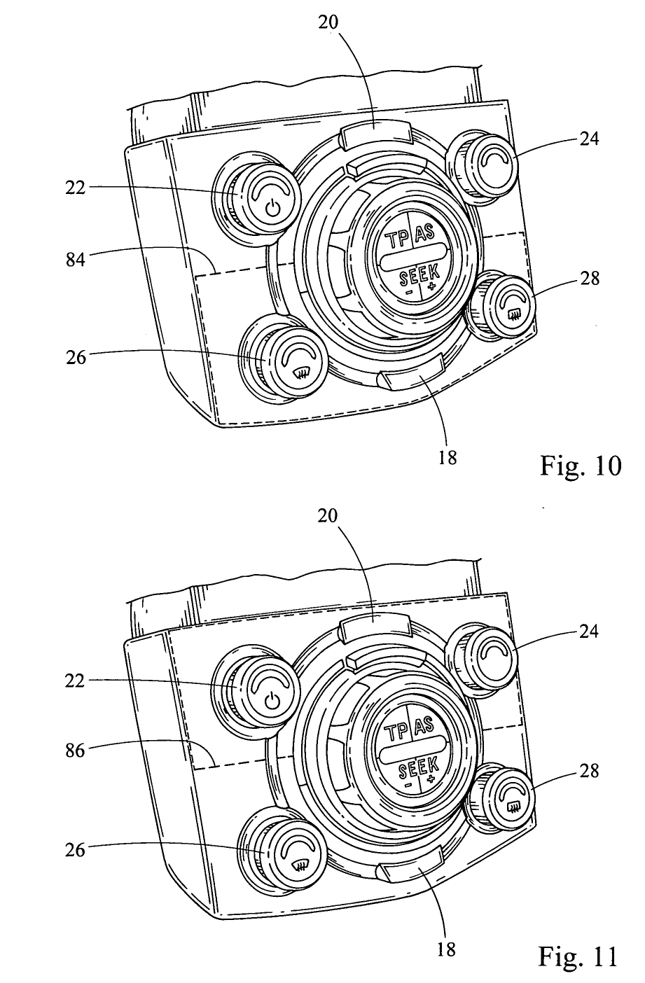

The HMI unit 10 includes four additional knobs 30, 32, 34, 36 located about the first knob 12. Each of the additional knobs is in communication with the controller 16. Each knob is rotatable and includes integrated push button capability, such that the knob will provide the controller 46 a signal when the knob is depressed. Two of the knobs, knobs 30, 32, are located above the first knob 12 and may control primarily audio related functions. As such, an audio control area 86 is defined where the primary audio controls are located above the first knob 12, as indicated in FIG. 11. Similarly, the other two knobs, knobs 34, 36, may control comfort related functions and define a comfort control area 84 below the first knob 12, as indicated in FIG. 10. Further, each knob includes a unique tactile indicator for differentiation by feel. The unique tactile indicator may include a unique knob surface profile or knob geometry. The discussion that follows is illustrative of how the knobs 30, 32, 34 and 36 may be employed.

The knob 30 is located on the upper left of the first knob and is configured to control the volume of the audio system when rotated. Pressing the knob 30 toggles the audio system on and off.

The knob 32 is located on the upper right side of the first knob 12. Rotating the knob 32 controls the station selection or title selection depending on the active audio input device. One short push on the knob 32 causes the controller 46 to scan the station or skip the current song. A sustained push of the knob 32 would cause the controller 46 to store the station or add the current title to a play list.

The knob 34 is located on the lower left of the first knob 12. The knob 34 is rotated to control the desired temperature for the driver of the vehicle. Pressing the knob 34 also activates a windshield demist function.

Located on the lower right of the first knob 12 is the knob 36. Rotating the knob 36 controls the desired temperature for the passenger of the vehicle. The knob 36 also activates rear window heating when pressed.

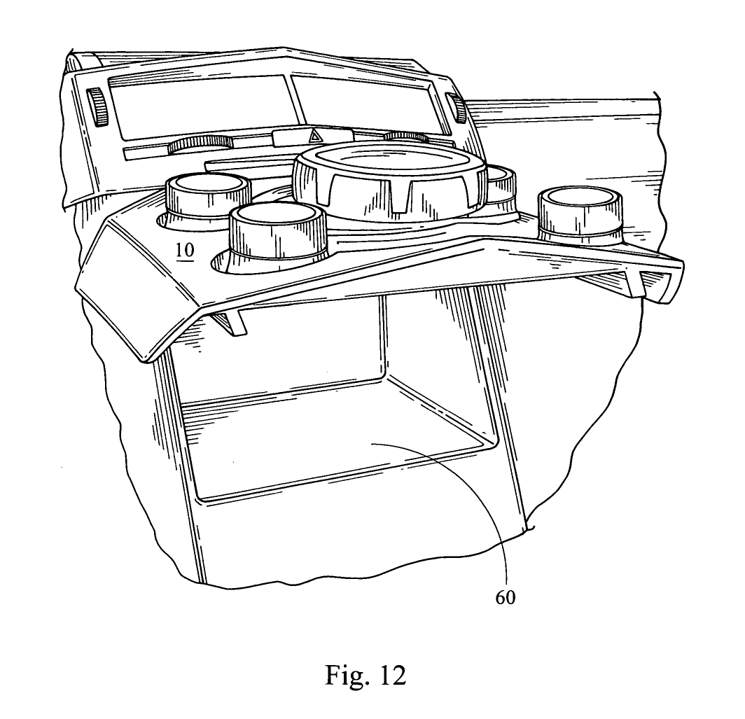

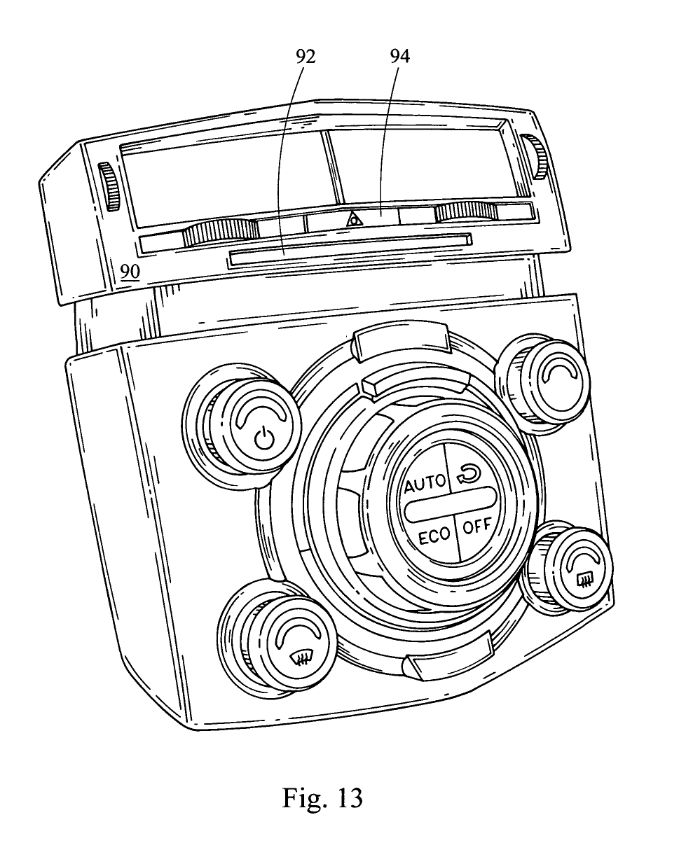

A storage unit 60 may be located behind the HMI unit 10 such that the face of the HMI unit 10 acts a cover for the storage unit 60. To access the storage unit 60, the face of the HMI unit 10 flips upwardly, as shown in FIG. 12, or alternatively downward. The storage unit 60 may include a cross sectional area as large as the face of the HMI unit 10 or larger. The storage unit 60 is in communication with the controller 46 to communicate with a personal device located in the storage unit 60. For example, if a PDA (personal digital assistant) or similar device is located in the storage unit, the storage unit 60 may include a transmitter/receiver 62 to wirelessly communicate with the PDA. One such wireless communication technology is Bluetooth™. The controller 46 may communicate with the personal device to access information, such as songs, for playing in the vehicle entertainment system, contact information for use in phone or navigation systems, or various other application software to provide trip information for expense software or text or verbal information for word processing.

As shown in FIG. 13, the HMI unit 10 also includes an integrated air register unit 90 with an audio CD drive 92 and hazard warning 94 switch. The integrated air register unit 90 provides for improved space usage and unique styling options.

As a person skilled in the art will readily appreciate, the above description is meant as an illustration of the principles this invention. This description is not intended to limit the scope or application of this invention in that the invention is susceptible to modification, variation and change, without departing from spirit of this invention, as defined in the following claims.

I/We claim:

1. An HMI unit for a vehicle, the HMI unit comprising a knob including a rotatable portion configured to provide user input and an integrated electronic display, wherein the integrated electronic display is located inside the rotatable portion.

2. The HMI unit according to claim 1, wherein the rotatable portion is received about the integrated electronic display, the integrated electronic display having a fixed orientation, and the rotatable portion being configured to rotate about the integrated electronic display.

3. The HMI unit according to claim 1, wherein the rotatable portion is received about the integrated electronic display, the integrated electronic display being configured to rotate together with the rotatable portion.

4. The HMI unit according to claim 1, further comprising a protrusion located adjacent the knob for use as a finger rest.

5. The HMI unit according to claim 1, further comprising:
controls for providing user input and a proximity sensor for sensing user motion proximate the controls.

6. The HMI unit according to claim 1, wherein the knob includes a touch sensor for sensing user contact with the knob.

7. The HMI unit according to claim 1, further comprising:
user controls for receiving user input,
a controller in electrical communication with the user controls,
an electronic display in communication with the controller, the controller being configured to display a symbol indicative of a user control function corresponding to one of the controls, and
wherein the controller is configured to fill the background of the electronic display based on the one of the controls.

8. The HMI unit according to claim 1, further comprising a plurality of menu buttons, each menu button being configured to index through menus for a function category, the knob being configured to index through menu choices on each menu.

9. The HMI unit according to claim 1, wherein the integrated electronic display is a round electronic display, a plurality of buttons are located radially about the round electronic display wherein a segment of the display includes indicia aligned with a button indicating a current button function.

10. The HMI unit according to claim 9, wherein each button of the plurality of buttons is in the shape of an arc and is located to form a continuous circle about a round electronic display.

11. The HMI unit according to claim 1, the HMI unit comprising:
a panel including a plurality of controls and a storage unit located behind the panel, the panel being configured to move relative to the storage unit to expose a storage unit opening.

12. The HMI unit according to claim 11, wherein the storage unit is in electrical communication with a power source and configured with a wireless charging technology to charge items stored in the storage unit.

13. The HMI unit according to claim 11, wherein the storage unit includes a transmitter receiver in communication with a controller, the transmitter receiver being configured to communicate wirelessly with items located in the storage unit.

14. The HMI unit according to claim 1, the HMI unit including a plurality of controls, a first set of controls corresponding to a first function category, a second set of controls corresponding to a second function category, and a third set of controls being multiplexed to correspond to both the first and second function category, wherein the first set of controls are located within a first contiguous region and the second set of controls are located in a second contiguous region, the first region not overlapping the second region, and the third set of controls being located between the first and second region.

15. The HMI unit according to claim 1, wherein at least one of display accents on the display, a menu structure on the display, and a ring light around the integrated electronic display provides a color consistent with a predefined color for a function category.

16. The HMI unit according to claim 1, further comprising a plurality of auxiliary knob controls, each auxiliary knob control having a unique tactile indicator for differentiation by feel.

17. The HMI unit according to claim 16, wherein the unique tactile indicator is the profile of the knob surface.
